(19) United States
(12) Patent Application Publication
(10) Pub. No.: US 2015/0193720 A1
(43) Pub. Date: Jul. 9, 2015

(54) ASSESSING TECHNOLOGY ISSUES

(71) Applicant: Bank of America Corporation, Charlotte, NC (US)

(72) Inventors: Sandeep Uthra, Waxhaw, NC (US); Robert J. Armstrong, Charlotte, NC (US); Mike McEllen, Charlotte, NC (US)

(73) Assignee: Bank of America Corporation, Charlotte, NC (US)

(21) Appl. No.: 14/150,611

(22) Filed: Jan. 8, 2014

(51) Int. Cl. G06Q 10/06

(52) U.S. Cl. CPC G06Q 10/063112

(57) ABSTRACT

Methods, systems, computer-readable media, and apparatuses for assessing the criticality of a technology issue or incident are presented. In some embodiments, a computing device may receive customer experience data regarding a technology incident and one or more pieces of additional information including a flame chart regarding similar technology incidents. Subsequently, the computing device may assess the customer experience data based on the flame chart. The computing device may then generate an impact assessment of the technology incident based on the assessment of the customer experience data, and identify one or more triage options, based on the impact assessment, in response to the technology incident. Subsequently, the computing device may notify one or more subject matter experts to implement the one or more triage options. In response to determining that a difference exists, the computing device may provide a notification that the technology issue has been resolved.

### BACKGROUND

Aspects of the disclosure relate to computer hardware and software. In particular, one or more aspects of the disclosure generally relate to computer hardware and software for assessing the criticality of a technology issue or incident.

Technology issues or incidents can arise for any business and, generally, the faster the technology issues are resolved the better. This is even more true where the technology at issue is critical to the business. For example, a financial institution experiencing a technology incident that effects financial transactions will generally want to correct the technology incident as fast as possible. However, when there are multiple incidents that arise the incidents need to be prioritized so the most urgent incidents are addressed first. In assessing the technology incidents to determine the criticality and urgency of each incident, as well as in determining how to respond to each incident, members from different teams (which may include, e.g., a technology team, a business team, and/or the like) may provide separate perspectives as to how critical and urgent each issue is. Such an assessment may require multiple teams reviewing a plurality of information, which can take time and can delay implementation of a response to the technology incident.

### SUMMARY

Aspects of the disclosure provide effective, efficient, and convenient ways of assessing the criticality of a technology issue or incident. In particular, certain aspects of the disclosure provide techniques for receiving information regarding a technology incident and assessing the criticality of that technology incident so as to assign a team to address the incident.

For example, some aspects of the disclosure provide ways of receiving, at a computing device, customer experience data regarding a technology incident, as well as receiving, at the computing device, one or more pieces of additional information, such as a flame chart regarding similar technology incidents. Subsequently, the computing device will assess the customer experience data in view of the flame chart. The computing device will then generate an impact assessment of the technology incident. Further, the computing device will identify one or more triage options in response to the technology incident and will then notify one or more subject matter experts to implement the one or more triage options.

By providing processing engines and incident triage systems in accordance with one or more aspects of the disclosure, an organization may respond more quickly to technology incidents by identifying and assessing technology incidents in view of a flame chart, including identifying one or more triage options in response to the technology incidents. For instance, by having a processing engine generate incident triage responses, as discussed below, an organization may better notify one or more subject matter experts to implement the one or more triage options more quickly.

Thus, in some embodiments discussed below, a computing device may receive one or more pieces of information in addition to the flame chart, including subject matter expert information (which may include, e.g., information regarding experts who have addressed similar technology incidents), guidebooks and playbooks regarding similar technology incidents (which may include, e.g., historic metric data from previous similar technology incidents and data regarding the response to such technology incidents), documents regarding similar technology incidents (which may include, e.g., historic metric data from previous similar technology incidents and data regarding the response to such technology incidents), historic customer transaction data regarding similar technology incidents (which may include, e.g., customer behavior data and history of customer transactions) and/or the like. Subsequently, the received guidebooks and documents may be distributed by the computing device to the subject matter experts.

In some instances, a computing device may generate an impact assessment, where the impact assessment may include assigning a priority level to a technology incident. Additionally, in some instances, a flame chart may include forecasting information regarding similar technology incidents as those of the identified technology incidents by the customer experience data. In certain instances, the forecasting information may include one or more pieces of data including time of day, processing volume (e.g., projected remaining volume to be processed at a given hour), failed customer interactions (e.g., how many customers will an incident directly result), productivity hours lost (e.g., how many paid employee hours will be lost as a result of an incident), priority of incident (e.g., what priority is this application at this time of day), visibility of incident (e.g., how visible will an issue with this application at this time of day be), stability (e.g., a measure of application stability), urgency (e.g., a measure of processing urgency), score (e.g., a function of hourly urgency and current stability providing an estimation of the business impact), and/or the like. In some instances, the customer experience data regarding the technology incident may be received via a mobile application. Additionally and/or alternatively, the customer experience data may be received via a customer phone call to a help desk.

In some instances, the decision engine may additionally include providing a notification that the technology incident has been addressed and/or resolved. The notification may be an alert through the mobile application.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented;

FIG. 1B illustrates another example operating environment in which various aspects of the disclosure may be implemented;

FIG. 2 illustrates an example of a system for identifying a response to a technology incident according to one or more embodiments;

FIG. 3 illustrates a flowchart that depicts a method of assessing the criticality of a technology incident according to one or more embodiments; and

FIG. 4 illustrates an example of a user interface that may be displayed in providing technology incident criticality information in one or more embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

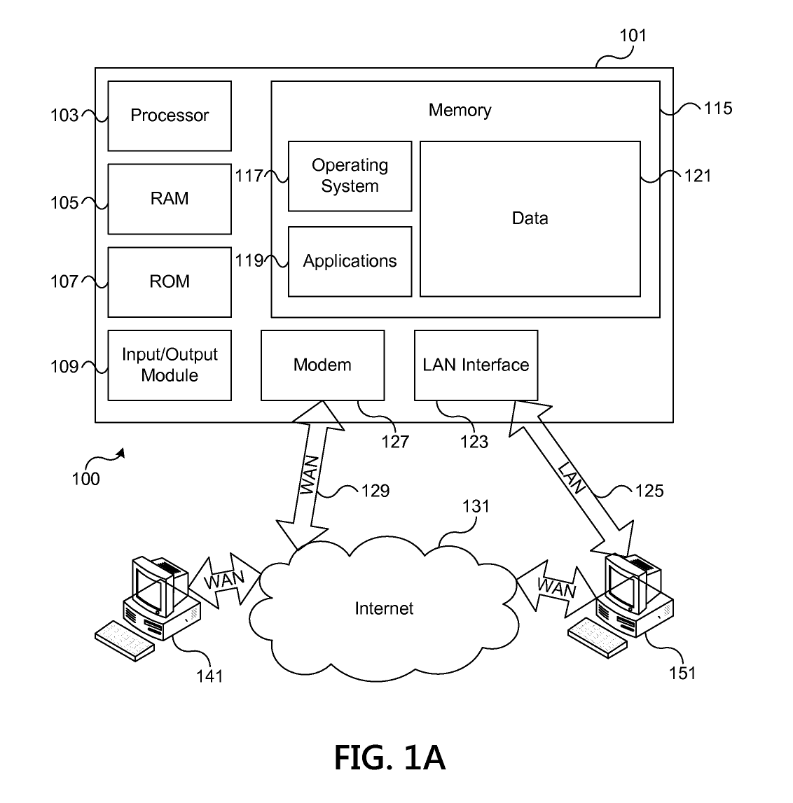

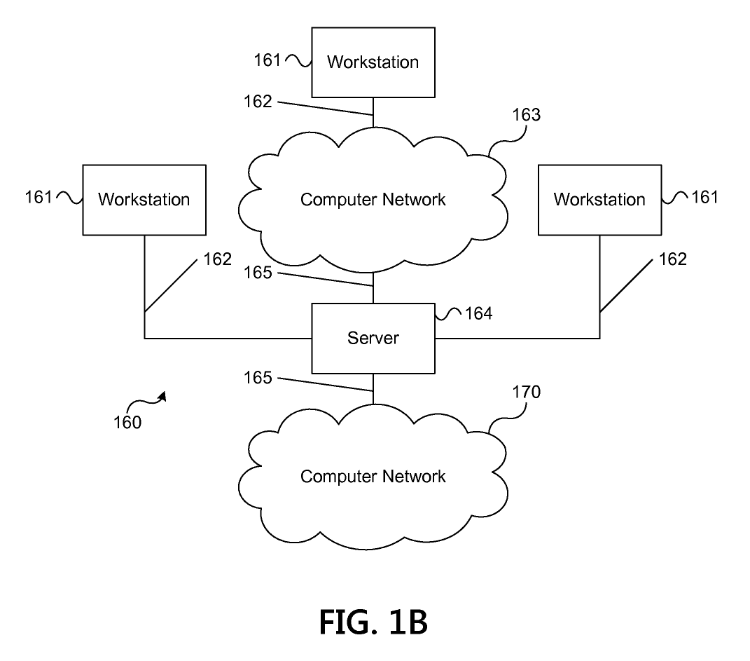

As noted above, certain embodiments are discussed herein that relate to assessing the criticality of a technology incident. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail. As introduced above, some aspects of the disclosure generally relate to assessing the criticality of a technology incident or issue. In the discussion below, various examples illustrating how the criticality of a technology incident may be assessed using a processing engine in accordance with one or more embodiments will be provided.

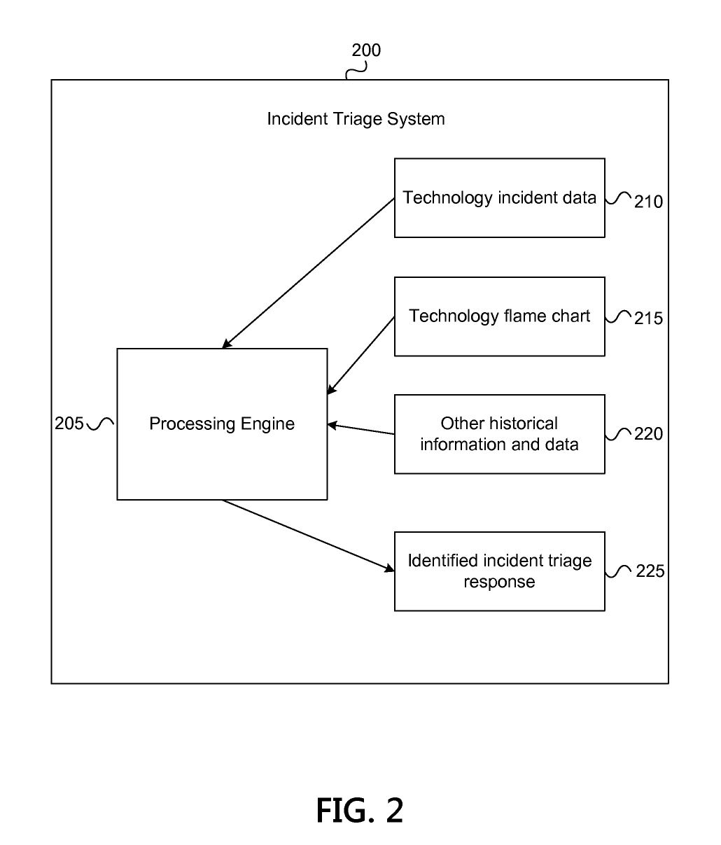

FIG. 2 illustrates an example of a system 200 for assessing the criticality of a technology incident according to one or more embodiments. In some embodiments, system 200 may be implemented in one or more computing devices, which may include and/or incorporate one or more processors, one or more memories, and/or one or more aspects of the computing device 101 discussed above. In some instances, system 200 may include a number of different subsystems, databases, and/or libraries. In some arrangements, all of the databases included in system 200 may be included in and/or incorporated into a single computing device, while in other arrangements, each database included in system 200 (and/or combinations thereof) may be included in and/or incorporated into a distinct and/or dedicated computing device.

As seen in FIG. 2, in some embodiments, incident triage system 200 may include a processing engine 205. Processing engine 205 may be configured to receive various types of information, such as technology incident data 210, technology flame chart 215 and other historical information and data 220. Processing engine 205 may be configured to send and/or exchange various types of information with one or more other devices, which may include identifying an incident triage response 225 in response to a technology incident. For instance, processing engine 205 may be configured to identify and provide an incident triage response 225 based on and/or in response to technology incidents identified and reported by customers. This arrangement represents one example configuration of system 200. In other embodiments, one or more elements of system 200 may be combined and/or additional and/or alternative types of information and/or requests may be included and/or handled in addition to and/or instead of those shown in FIG. 2.

In some embodiments, processing engine 205 may be configured to collect and process information. In one or more arrangements, the information that is collected and/or processed by processing engine 205 may include technology incident data 210. In some instances, the technology incident data 210 may include information about one or more technology incidents (which may include, e.g., customer experience data) occurring within a financial institution (e.g., the financial institution that is implementing system 200). Such data may include information identifying the technology that is experiencing the incident, information regarding a customer's past and present experience with the technology, information and details regarding the technology incident itself, and the like. In some instances, technology incident data may be received from a mobile application (e.g., a user may input information regarding a technology incident into a mobile application). Additionally or alternatively, technology incident data may be received as an alert from a help desk (e.g., a user may call a help line and report the technology incident). Incident triage system 200 may be configured to receive and store the technology incident data (which may, e.g., enable processing engine 205 to respond to future technology incidents using technology incident metric data).

Processing engine 205 may also be configured to collect and process technology flame charts 215. Technology flame charts 215 may include information regarding similar technology incidents as those discussed above with respect to processing engine 205. Technology flame charts 215 may include information about the criticality of technology incidents. For example, flame charts may include one or more pieces of data (which may include, e.g., time of day, processing volume, failed customer interactions, productivity hours lost, priority of incident, visibility of incident, stability, urgency, score, and the like), which may be used to measure the criticality of a technology incident and/or to estimate business impact of a technology incident. In some instances, a flame chart may provide forecasting information regarding a technology incident (e.g., providing a snapshot of the possible impact of an incident by time for an application). In certain instances, the flame chart is based on historical data. In alternative instances, the flame chart is based on dynamic data (e.g., data will be fed continuously into a flame chart, so the chart will be updated continuously). In certain instances, processing engine 205 may receive flame chart information from another system (e.g., a flame chart modeling system) or database. Additionally or alternatively, processing engine 205 may receive and store technology incident data and may generate a flame chart utilizing the stored technology incident data.

In some embodiments, processing engine 205 may be further configured to receive other historical information and data 220. In particular, processing engine 205 may be configured to receive additional information regarding technology incidents similar to those discussed in step 205. Additional historic information and data may include information regarding similar technology incidents that was collected from past technology incidents. In some instances, such historic information and data may include information regarding the technology incident itself, as well as information regarding the implemented response to the technology incident. The information may be in the form of guidebooks or playbooks (which may include, e.g., documents detailing past responses to technology incidents), other documents regarding similar technology incidents (which may include, e.g., documents detailing similar technology incidents), and the like.

In certain embodiments, other historical information and data may additionally include information regarding customer transactions. In some instances, processing engine 205 may receive historical data regarding customer transactions (e.g., big data). For example, processing engine 205 may receive customer credit card transactions (which may include, e.g., capturing the swiping of a credit card, use of online banking, and the like). In some instances, customer transaction history data is utilized to identify customer patterns (e.g., which applications are accessed by a customer), identify key impacted technology areas (e.g., technology areas that are accessed most often by a customer) and predict the stability of technology (e.g., an increase of volume may trigger technology instability).

In one or more arrangements, processing engine 205 may be configured to identify one or more incident triage responses 225 in response to processing received information. Identifying one or more incident triage responses may, for example, be based on any and/or all of the information the processing engine 205 may receive in connection with technology incident data 210, technology flame chart 215, other historical information and data 220, and/or other information that the processing engine 205 may collect, aggregate, update, store, and/or otherwise maintain. Processing engine 205 may, for instance, identify one or more incident triage responses to address a technology incident. For example, in generating incident triage responses 225 and subsequently transmitting them, the processing engine 205 may analyze the received information, identify a triage response that is capable of addressing the technology incident, and transmit the identified incident triage response. In some embodiments, the analysis of the received information may include, for example, identifying the criticality of a technology incident (e.g., identifying how fast a response should be implemented to address the incident). In identifying a triage response, the processing engine may retrieve past triage responses from the historical information and data obtained in step 220. The identified triage response may then be transmitted, in some instances, to subject matter experts.

As indicated above, these are examples of the elements that may be included in system 200 in some embodiments, as well as some of the functions that may be performed (e.g., by system 200). In other embodiments, additional and/or other elements may similarly be included and/or other functions may be performed, in addition to and/or instead of those discussed above.

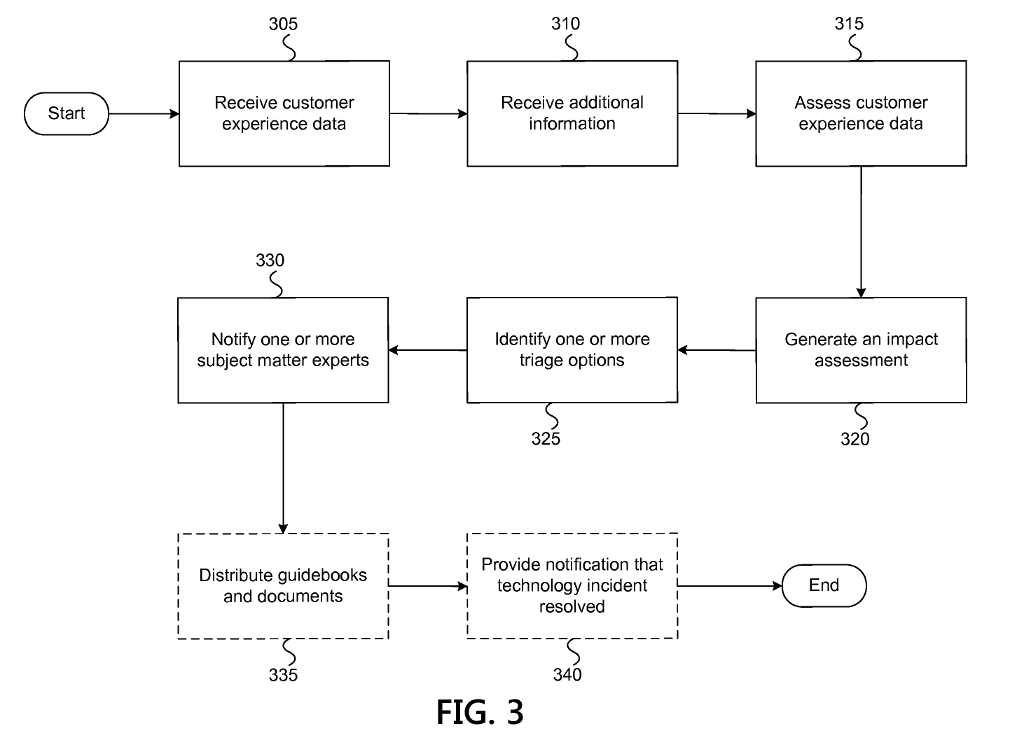

Having described an example system that may be used in assessing the criticality of a technology incident in some embodiments, an example of a method that may, in some embodiments, be performed (e.g., by such a system 200; by another computing device, such as computing device 101; and/or the like) will now be discussed in greater detail with respect to FIG. 3.

FIG. 3 illustrates a flowchart that depicts a method of assessing criticality of a technology incident according to one or more embodiments. In some embodiments, the example method illustrated in FIG. 3 may be performed by a computing device, which may include and/or implement one or more aspects of computing device 101. In additional and/or alternative embodiments, the example method illustrated in FIG. 3 may be performed by a computer system, such as system 200. In other embodiments, the example method illustrated in FIG. 3 may be implemented in and/or may otherwise be embodied in computer-readable instructions that may be stored in a computer-readable medium, such as a memory.

As seen in FIG. 3, the method may be initiated in step 305, in which customer experience data may be received. For example, in step 305, a computing device (e.g., computing device 101, system 200, and/or the like) may receive customer experience data regarding a technology incident. The customer experience data may, for instance, include information identifying one or more technology incidents. In some instances, customer experience data may include information identifying the technology that is experiencing the incident (which may include, e.g., details regarding what application the technology affects, how the technology is traditionally used and the like), information regarding a customer's past and present experience with the technology (which may include, e.g., how the customer has used the technology, what the customer was doing before the incident, and the like), information and details regarding the technology incident itself (which may include, e.g., what the customer was doing when the technology failed, what happened when the technology failed, and the like), and the like.

In some embodiments, in receiving customer experience data, the computing device may, for example, receive the customer experience data from a mobile application. For example, a customer may input customer experience data into a mobile application, which may then transmit the received data to a computing device. The customer will not get feedback on the mobile device when communication is initiated via a call into the helpdesk. Feedback to the mobile device only occurs when communication to the helpdesk is imitated via the mobile device.

In step 310, one or more pieces of additional information may be received. For example, in step 310, the computing device may receive one or more pieces of additional information including a flame chart regarding similar technology. The flame chart may be technology specific (e.g., there may be multiple flame charts, each corresponding to a different technology). In some instances, the flame chart includes business forecasting information for technology incidents based on historical data. In some embodiments, the flame chart may identify and display the changes in the criticality of responding to a technology incident at different times of day (e.g., a technology incident that occurs to an application during a high customer use period will have a larger impact on the business and having a higher level of criticality, than a technology incident that occurs during a low customer use period). In certain embodiments, a flame chart may be selected from a database where the flame chart corresponds to a technology similar to the technology incident. For example, a computing device may identify the subject technology of the incident based on the received customer experience data, and may then select a flame chart for a similar technology from a database.

In some instances, a flame chart is generated to provide a predictive model of the criticality of a technology incident at various times of day. The flame chart may include and/or display a plurality of forecasting data. Such data may include the time of day, a processing volume (e.g., data to be processed at any given time), failed customer interactions (e.g., how many customers will be impacted by an incident), productivity hours lost (e.g., how many paid employee hours will be lost as a result of an incident), priority of incident (e.g., three levels of priority for each incident calculated based on volume and stability values), visibility of incident (e.g., three levels of visibility indicating the likelihood that the incident will appear in social media or made public), stability (e.g., a stability predicative model summarizing whether the right version of the technology is working, all licenses are current, all certificates are in place, firewall is in place, and the like), urgency (e.g., how urgent is it to respond to technology incident immediately), score (e.g., a function of hourly urgency and current stability providing an estimation of the business impact). In some instances, the data for the processing volume, failed customer interactions and productivity hours lost may be determined based on measured metrics and historic data. Additionally, in some instances, the data for the priority analysis, impact analysis, visibility analysis, stability analysis and urgency analysis may be determined manually. In alternative embodiments, the flame chart will receive data dynamically and will be continuously updated.

In some embodiments, the one or more pieces of additional information received in step 310 may include subject matter expert information (e.g., information regarding individuals who are experts in the technology at issue), guidebooks and playbooks regarding similar technology incidents (which may include, e.g., documents detailing response implementation to technology incidents, information regarding subject matter experts to implement responses to technology incidents, and the like), documents regarding similar technology incidents (which may include, e.g., documents detailing history of similar technology incidents, documents detailing response actions to technology incidents, and the like), historic customer transaction data regarding similar technology incidents (e.g., historical data detailing customer banking transactions, identifying customer transaction patterns, and the like), and the like. In some instances, the additional information may provide details regarding past technology incidents that are similar to the technology incident at issue. Additionally or alternatively, the additional information may provide details regarding how the past technology incidents were responded to (e.g., how the technology incident was repaired). Further, the additional information may provide details regarding the possible business impact of such technology incidents.

In step 315, customer experience data may be assessed. For example, in step 315, the computing device may assess the customer experience data received in step 305 in view of the flame chart received in step 310. In some instances, the customer experience data identifying a technology incident may be assessed in view of a flame chart providing information regarding a similar technology incident. Additionally or alternatively, the customer experience data may be assessed in view of the additional information received, such as guidebooks and playbooks, historic customer data, and other materials relevant to the technology incident.

In step 320, an impact assessment may be generated. For example, in step 320, the computing device may generate an impact assessment of the technology incident. An impact assessment may identify how the technology incident will affect customers. In some instances, the impact assessment may include identifying and assigning a priority level to the technology incident (e.g., identifying how quickly the technology incident should be repaired). In some instances, the priority level may be dependent on the business impact of the technology incident. Additionally, the generated impact assessment may identify multiple levels of priority for responding to a technology incident depending on the time of day the technology incident occurs. For example, the urgency for responding to a technology incident at a time of day where the incident will have a larger business impact is higher than a time of day when the incident will have less of a business impact. In some instances, the priority level of a first technology incident may be higher than the priority level of one or more other technology incidents.

In step 325, one or more triage options may be identified. For example, in step 325, the computing device may identify one or more triage options in response to the technology incident. One or more triage options may include response options to address the technology incidents. In some instances, a triage option may be generated and identified by the computing device. In alternative embodiments, a triage option may be identified from previously obtained materials, such as from guidebooks or playbooks. A triage option may provide a response to a technology incident based on an assessment of the technology and the business. In some instances, a triage response may include a repair to the technology at issue (which may include, e.g., a roll back, a patch, and/or the like).

In step 330, one or more subject matter experts may be notified. For example, in step 330, the computing device may notify one or more subject matter experts to implement the one or more triage options. The subject matter experts may be individuals who have experience with the specific technology incident at issue. In some instances, the subject matter experts may be identified in the additional information received in step 310 by the computing device. In certain embodiments, the subject matter experts may have previously responded to past incidents of a similar technology. The subject matter experts may enable the one or more identified triage responses. In some instances, the subject matter experts may be classified by experience level. For example, a technology incident assigned a high level of priority will be assigned subject matter experts having a high level of experience.

In step 335, guidebooks and documents may be distributed. For example, in step 335, the computing device may distribute the guidebooks and documents received as additional information to the subject matter experts. In some instances, the previously obtained guidebooks, documents, and/or other materials regarding similar technology incidents may be transmitted to the subject matter experts. In some instances, the materials may provide response actions for responding to the technology incident (e.g., the materials may include instructions on how to respond to a technology incident based on previous technology incidents).

In step 340, a notification that the technology incident has been resolved may be provided. For example, in step 340, the computing device may provide a notification to the customer that the technology incident has been resolved. In some instances, a notification that a technology incident has been resolved may be transmitted as an alert to the device that initiated the incident. For example, a notification message may be sent to the mobile application that initially received the customer experience data regarding the technology incident. Additionally and/or alternatively, a notification may be transmitted to a customer by instant message, SMS message, push notification, e-mail, phone call, page, and/or the like.

In some arrangements, the information generated by the computing device may be collected and aggregated. Such information may be used to identify trends and triage response options in technology incidents, as well as to provide for more informed responses to technology incidents. For example, repeated occurrences of a specific technology incident may be identified. In certain aspects, a triage response is well established to respond to the specific technology incident that repeatedly occurs. Such information may be utilized in identifying the criticality of the technology incident and instituting a triage response quickly. In other instances, the information generated may be utilized to adjust response options recorded in the guidebooks and/or playbooks, or to identify new response options to the technology incident that may then be recorded in the guidebooks and/or playbooks. Additionally and/or alternatively, technology incident criticality information may be recorded and/or updated in the materials (e.g., a technology incident flame chart may be updated in view of new technology incident information).

Subsequently, the method may end. As illustrated in the examples above, however, certain aspects of the assessment of the criticality of a technology incident or issue may be repeated (e.g., in receiving, updating and continuing to aggregate technology incident information and triage options in response to such incidents). Additionally or alternatively, the processing engine may perform similar steps as those illustrated in FIG. 3 and discussed above in assessing the criticality of a technology incident or issue.

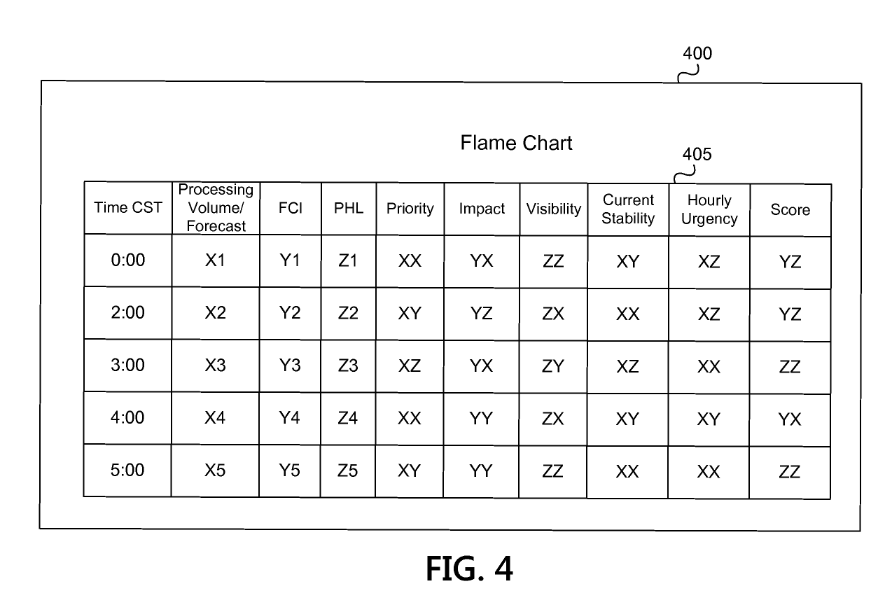

Having described several examples of the processing that may be performed by a computing device in assessing the criticality of a technology incident in some embodiments, an example user interface that might be displayed and/or otherwise provided by a computing device, such as computing device 101 and/or system 200, in performing such processing and/or in otherwise assessing the criticality of technology incidents and will now be discussed with respect to FIG. 4.

FIG. 4 illustrates an example of a user interface that may be displayed in providing technology incident criticality information in one or more embodiments. As seen in FIG. 4, in some instances, a computing device implementing one or more aspects of the disclosure (e.g., computing device 101, system 200, and/or the like) may display and/or otherwise provide a user interface 400 that includes a portion in which information about criticality of technology incidents can be displayed.

In some arrangements, user interface 400 may include a table 405 that may present and/or include information that is configured to identify the criticality of a technology incident. In particular, table 405 may include information regarding the criticality of a technology incident in response to the time of day the incident occurs, as well as the volume of processing that will be affected, the number of customers that will be affected, and the employee productivity hours that will be lost. Table 405 may include different categories of data including processing volume (e.g., projected remaining volume to be processed at a given hour), failed customer interactions (e.g., how many customers will an incident directly result), productivity hours lost (e.g., how many paid employee hours will be lost as a result of an incident), priority of incident (e.g., what priority is this application at this time of day), visibility of incident (e.g., how visible will an issue with this application at this time of day be), stability (e.g., application stability), urgency (e.g., a measure of processing urgency), score (e.g., function of hourly urgency and current stability providing an estimation of the business impact). In some instances, the value in each of the cells in the score column of table 405 may, for example, correspond to and/or represent a criticality of a technology incident at a specific time of day.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, the steps illustrated in the figures may be performed in other than the recited order, and one or more steps illustrated may be optional in accordance with aspects of the disclosure.

What is claimed is:

1. A method comprising:
receiving, by a computing device, customer experience data regarding a technology incident;
receiving, by the computing device, one or more pieces of additional information including a flame chart regarding similar technology incidents;
assessing, by the computing device, the customer experience data based on the flame chart;
generating, by the computing device, based on the assessing of the customer experience data, an impact assessment of the technology incident;
identifying, by the computing device, based on the impact assessment, one or more triage options in response to the technology incident; and
notifying, by the computing device, one or more subject matter experts to implement the one or more triage options.

2. The method of claim 1, further comprising providing, by the computing device, a notification that the technology issue has been resolved.

3. The method of claim 1, wherein the impact assessment includes assigning a priority level to the technology incident.

4. The method of claim 1, wherein the flame chart includes forecasting information for the similar technology incidents.

5. The method of claim 4, wherein the forecasting information includes one or more pieces of data including: time of day, processing volume, failed customer interactions, productivity hours lost, priority of incident, visibility of incident, stability and urgency.

6. The method of claim 1, wherein the customer experience data is received from a mobile application.

7. The method of claim 1, wherein the additional information further includes: subject matter expert information, guidebooks and playbooks regarding similar technology incidents, documents regarding similar technology incidents, and historic customer transaction data regarding similar technology incidents.

8. The method of claim 7, further comprising distributing the received guidebooks and documents to the subject matter experts.

9. One or more non-transitory computer-readable media having computer-executable instructions stored thereon that, when executed by a computing device, cause the computing device to:
receive customer experience data regarding a technology incident;
receive one or more pieces of additional information including a flame chart regarding similar technology incidents;
assess the customer experience data based on the flame chart;
generate, based on the assessment of the customer experience data, an impact assessment of the technology incident;
identify, based on the impact assessment, one or more triage options in response to the technology incident; and
notify one or more subject matter experts to implement the one or more triage options.

10. The one or more non-transitory computer readable media of claim 9, having additional computer-executable instructions stored thereon that, when executed by the computing device, further cause the computing device to:
provide a notification that the technology issue has been resolved.

11. The one or more non-transitory computer readable media of claim 9, wherein the impact assessment includes assigning a priority level to the technology incident.

12. The one or more non-transitory computer readable media of claim 9, wherein the flame chart includes forecasting information for the similar technology incidents.

13. The one or more non-transitory computer readable media of claim 12, wherein the forecasting information includes one or more pieces of data including: time of day, processing volume, failed customer interactions, productivity hours lost, priority of incident, visibility of incident, stability and urgency.

14. The one or more non-transitory computer readable media of claim 9, wherein the customer experience data is received from a mobile application.

15. The one or more non-transitory computer readable media of claim 9, wherein the additional information further includes: subject matter expert information, guidebooks and playbooks regarding similar technology incidents, documents regarding similar technology incidents, and historic customer transaction data regarding similar technology incidents.

16. The one or more non-transitory computer readable media of claim 15, having additional computer-executable instructions stored thereon that, when executed by the computing device, further cause the computing device to:
distribute the received guidebooks and documents to the subject matter experts.

17. A computing device, comprising:
at least one processor; and
memory storing computer readable instructions that, when executed by the at least one processor, cause the computing device to:
receive customer experience data regarding a technology incident;
receive one or more pieces of additional information including a flame chart regarding similar technology incidents;
assess the customer experience data based on the flame chart;
generate, based on the assessment of the customer experience data, an impact assessment of the technology incident;
identify, based on the impact assessment, one or more triage options in response to the technology incident; and
notify one or more subject matter experts to implement the one or more triage options.

18. The computing device of claim 17, wherein the memory stores additional computer readable instructions that, when executed by the at least one processor, further cause the computing device to:
provide a notification that the technology issue has been resolved.

19. The computing device of claim 17, wherein the impact assessment includes assigning a priority level to the technology incident.

20. The computing device of claim 17, wherein the flame chart includes forecasting information for the similar technology incidents.

21. The computing device of claim 20, wherein the forecasting information includes one or more pieces of data including: time of day, processing volume, failed customer interactions, productivity hours lost, priority of incident, visibility of incident, stability and urgency.

22. The computing device of claim 17, wherein the customer experience data is received from a mobile application.

23. The computing device of claim 17, wherein the additional information further includes: subject matter expert information, guidebooks and playbooks regarding similar technology incidents, documents regarding similar technology incidents, and historic customer transaction data regarding similar technology incidents.

24. The computing device of claim 23, wherein the memory stores additional computer readable instructions that, when executed by the at least one processor, further cause the computing device to:
distribute the received guidebooks and documents to the subject matter experts.
